(19) United States
(12) Patent Application Publication
(10) Pub. No.: US 2026/0184365 A1
(43) Pub. Date: Jul. 2, 2026

(54) STEERING INPUT DEVICE FOR SPECIFYING A STEERING MOVEMENT ACCORDING TO THE STEER-BY-WIRE CONCEPT AND METHOD FOR OPERATING A STEERING INPUT DEVICE

(71) Applicant: INVENTUS Engineering GmbH, St. Anton i.M. (AT)

(72) Inventors: Stefan Battlogg, St. Anton i.M. (AT); Philipp Dönz, Silbertal (AT)

(21) Appl. No.: 18/857,023

(22) PCT Filed: Apr. 12, 2023
(86) PCT No.: PCT/EP2023/059528

§ 371 Date: Oct. 15, 2024

(30) Foreign Application Priority Data
Apr. 12, 2022 (DE) 10 2022 108 887.1

(51) Int. Cl. B62D 5/00; B62D 6/00; G07C 5/08

(52) U.S. Cl. CPC B62D 5/006; B62D 6/00; G07C 5/0808

(57) ABSTRACT

A steering input device for specifying a steering movement according to the steer-by-wire concept, with a moveable steering unit and a drive device for generating a torque acting on the steering unit. A fault protection system, in the event of a fault of the drive device, operates the steering unit by neither being blocked nor moved without resistance. The fault protection system has a braking device that is independent of the drive device, and has a maximum braking torque that is less than a maximum torque of the drive device. The fault protection system is configured to actuate the braking device in the event of a malfunction of the drive device, and to thereby brake the movement of the steering unit with a targeted emergency braking torque.

The invention relates to a steering input device for inputting a steering movement according to the steer-by-wire concept. The steering input device comprises at least one movable steering unit and at least one drive device for generating a torque acting on the steering unit.

High demands are placed on such steering control devices. For example, precise steering feedback and backlash-free or jerk-free steering behavior, especially around the center position, as well as very smooth, harmonious steering behavior are required. In addition, the steering device must provide high torque or be able to counteract the manual steering movement (the torque then corresponds to a braking torque). This is e.g., to represent end stops, for support when getting out or as a counter torque during very fast twisting or steering movements.

Therefore, steering systems with an electric motor have become known, which is coupled to the steering wheel either directly or via a reduction gear or (toothed) belt. Such directly attached electric motors generate, for example, active braking torques (nominal torques) of up to eight Newton meters (Nm) and short-term passive braking torques of up to 25 Nm.

A steer-by-wire steering system for a motor vehicle with a three-phase synchronous motor as a direct drive for actively moving the steering wheel and with a magnetorheological brake is known from DE 10 221 241 A1.

The stator of the synchronous motor is fixed to a dashboard. The rotor is non-rotatably connected to an actuating shaft (steering shaft) via a hollow shaft. The actuating shaft is connected to the steering wheel. The magnetorheological brake has a ring magnet and a brake disk as well as a gap arranged between them for the magnetorheological fluid. The ring magnet is attached to the stator side. The brake disc is arranged in a rotating manner on the actuating shaft. The direct drive is used to reset the steering wheel after cornering. The magnetorheological braking device is provided to apply an active counter-torque to a steering movement exerted by the driver. This should have low power consumption and be able to provide a very high counter torque without excessive heating.

A further requirement for steering control devices relates to safety in the event of a malfunction and, for example, in the event of a power failure or a failure of the components for generating the torque (failsafe case). Because there is no longer any torque opposing the steering movement, steering is very easy, and no resistance is felt when steering.

For example, if an electric motor suddenly fails when turning into a curve, the torque in the steering train that counteracts the manual steering movement suddenly decreases. This can lead to an unintentional specification of a strong steering angle via the steering wheel (oversteering). This results in a very dangerous driving condition, which must be corrected by the driver. This can even lead to loss of control of the vehicle if, for example, the driver is driving on a winding mountain road either oversteers into the oncoming lane or over the edge of the road. The known steering systems with which such errors can be intercepted (redundant design) are usually very complex in structure, require a lot of installation space and are very cost intensive.

If the steering unit is generally designed to be (mechanically) stiff (=high basic torque), it is no longer possible to achieve haptically perfect control in normal operation (active resetting . . . ). Only very smooth-running steering units (preferably <0.1 Nm basic torque of all steer-by-wire steering components) enable haptically sophisticated and harmonious steering movements.

A steer-by-wire steering system with an electric motor for generating an active torque acting on the steering unit is known from EP 3 676 156 B1. A magnetorheological fluid and an electrical coil are housed in a bearing housing for a bearing of the motor shaft of the electric motor. By generating a magnetic field using the coil, the magnetorheological fluid solidifies, which means that a higher torque is required to rotate the motor shaft. This allows a passive torque or Braking torque is generated, which acts on the steering unit. The braking torque can be so high that end stops (end position lock) can be generated for the rotation of the steering unit. The bearing can also provide braking if the electric motor fails. To generate the magnetic field, the coil is supplied by a power source. When the power source is switched off, the bearing can only create a very small resistance to the movement of the motor shaft.

In contrast, the object of the present invention is to provide an improved steering input device. In particular, the steering input device should offer a high level of safety even in the event of a malfunction and at the same time be inexpensive to implement in terms of design and installation space and be economical to produce.

This task is solved by a steering input device with the features of claim 1. The method according to the invention is the subject of claim 24. Preferred developments of the invention are the subject of the subclaims. Further advantages and features of the present invention emerge from the general description and from the description of the exemplary embodiments.

The steering input device according to the invention is used to input a steering movement according to the steer-by-wire concept. The steering input device can e.g., to control a vehicle or to control a simulator device or a computer simulation (e.g., gaming). The steering input device comprises at least one movable steering unit and at least one drive device for generating a torque acting on the steering unit. The steering input device includes at least one fault protection system. The malfunction protection ensures that the steering unit is neither blocked nor can be moved without resistance in the event of a malfunction. The fault prevention includes at least one braking device that is independent of the drive device. The maximum braking torque of the braking device is less than (or equal to) the maximum torque of the drive device. The malfunction protection is suitable and designed to actuate the braking device in the event of a malfunction in the drive device and thereby (by means of the braking device) to brake the mobility of the steering unit with a targeted braking torque (hereinafter referred to as the malfunction braking torque).

The present invention offers many advantages. Malfunction protection offers a significant advantage with its braking device that is independent of the drive device. The inventive design of the maximum braking torque of the braking device is particularly advantageous. This enables very reliable and at the same time particularly inexpensive protection in the event of incidents. The height-limited braking torque counteracts the risk that the braking device itself becomes a critical source of error in the event of a fault in the drive device and, for example, blocks the mobility (twist) of the steering unit or brakes it too much.

The steering unit is in particular a steering wheel. The steering unit can alternatively also be designed as a steering wheel, yoke steering wheel, handlebar or handlebar, control stick, control horn, control pedal, control lever or as a joystick or as a control wheel. Other types of movable steering units for steering vehicles are also possible. The movement of the steering unit is in particular a rotary movement. In particular, the steering unit is movable and preferably rotatable in at least two directions of rotation. But pivoting or the like is also possible.

The steering control device can be used in motor vehicles (e.g. cars, trucks, ON-highway vehicles), aircraft, planes (including drones), ships, boats, in agricultural and forestry technology, for example tractors or combine harvesters, harvesters and others Field machines possible (OFF-Highway vehicles). It can also be used in construction or moving work machines and, for example, forklifts or similar machines, or in simulators for simulating vehicle control (gaming; sim racing; computer peripherals . . . ). The steering input device can in particular also be used for at least partially or completely autonomous vehicles.*

The maximum braking torque of the braking device is particularly preferably less than 6 Nm. The maximum braking torque is preferably between 0.1 Nm and 6 Nm. In particular, the maximum braking torque is less than 4 Nm and preferably less than 3.8 Nm. In particular, the maximum braking torque is between 1 Nm and 6 Nm and preferably between 1.5 Nm and 3.8 Nm. It is preferred and advantageous that the maximum braking torque is a maximum of 3.8 Nm and preferably a maximum of 3.6 Nm and particularly preferably a maximum of 3.5 Nm. Such designs of the maximum braking torque allow noticeable resistance in the event of a fault and still enable smooth mobility for safe steering.

In particular, the maximum braking torque and the emergency braking torque are tailored to the size of the steering unit (in particular the diameter of a steering wheel and/or steering wheel and/or the span of a handlebar). Depending on the steering wheel diameter, the necessary or maximum braking torques can vary, which feel good to the user or are acceptable in terms of safety. Larger steering wheel diameters require higher braking torques. The tangential forces of the operator (operating forces) on the diameter of the steering device (point of attack on the steering wheel rim) are decisive here. With a braking torque of 3.5 Nm and a diameter of 330 mm of the steering control device, tangential forces (which counteract the user's operating forces) of approx. 21 N result. Steering control devices in cars usually have a steering wheel diameter in this range (300 to 400 mm). Trucks usually have a steering wheel diameter of between 400 and 500 mm, which means that higher braking torques are permissible or haptically possible (e.g. tangential/operating force=21 N; steering wheel diameter=500 mm. This means that approx. 5.25 Nm is possible as the maximum braking torque). Conveniently, a maximum tangential force caused by the braking device on the steering control device (and in particular on the steering unit), which counteracts a user's operating force at a point of application of the steering unit, is less than 30 N and preferably a maximum of 20 N. The maximum tangential force corresponds to the maximum braking torque multiplied at a distance (of the point of attack) from an axis of rotation of the steering unit.

It is also possible that the maximum braking torque of the braking device corresponds to only a fraction of the maximum torque that can be provided by the drive device. In particular, the maximum braking torque is less than half and preferably less than a third and particularly preferably less than a quarter of the maximum torque of the drive device. The maximum braking torque can also be less than a fifth or a sixth or an eighth of the maximum torque of the drive device amount.

The maximum braking torque preferably corresponds to the emergency braking torque. In other words, the emergency braking torque is equal to the maximum braking torque. In particular, the maximum braking torque corresponds to the fault braking torque, so that the mobility of the steering unit is braked or can be braked by means of the braking device in the event of a fault in the drive device (preferably exclusively) with the maximum braking torque. This enables particularly simple and at the same time very safe emergency protection. The emergency braking torque can also be designed to be lower than the maximum braking torque.

Preferably, for technical reasons, the braking device cannot apply a braking torque that is higher than the emergency braking torque and/or the maximum braking torque. In particular, the maximum braking torque corresponds to the emergency braking torque. This offers the advantage that even if the braking device does not function properly, the steering unit cannot be braked too much or even blocked.

In particular, this means that the maximum braking torque cannot be exceeded even if the braking device is faulty. In particular, the braking device is designed in such a way that the mobility of the steering unit cannot be braked more than with the maximum braking torque. In particular, the braking device cannot block the mobility of the steering unit. In particular, the braking device is designed in such a way that it cannot set a braking torque higher than the maximum braking torque even if the control is faulty or incorrect. For this purpose, the brake is designed, for example, as described in more detail below (for example, magnetic saturation of the magnetic circuit is provided). By adapting the design of the braking device to the maximum braking torque, country-specific or regionally different requirements and specifications can be taken into account.

The braking device preferably has a fixed fault braking torque. In particular, the emergency braking torque is technical or given for structural reasons. In particular, the emergency braking torque is constant. In particular, the emergency braking torque is not designed to be adjustable. In other words, in the event of a fault, the braking device always brakes with a fixed and in particular constant braking torque. As a result, even if control of the braking device fails, a suitable emergency braking torque can still be provided for braking the steering unit. In such configurations, the emergency braking torque corresponds in particular to the maximum braking torque or is below it.

However, it is also possible and advantageous for the braking device to be designed in such a way that the emergency braking torque is adjustable. Preferably, even then, for technical reasons, no higher emergency braking torque can be set than the maximum braking torque.

In a preferred and advantageous embodiment, it is provided that the mobility of the steering unit can be braked by means of the braking device either only with the emergency braking torque or not at all. This also offers particularly reliable, and at the same time inexpensive, protection against faults. In particular, the braking device can only apply the emergency braking torque in a braked switching state. If the braking device does not brake the mobility of the steering unit at all, there is in particular only a basic torque of the braking device and in particular no active braking torque. It is very important that the basic torque of the braking device is as low as possible so that sensitive steering is possible in normal operation and the controllability of the drive device can function well (open/closed loop systems). Basic torques of <0.1 Nm, preferably <0.05 Nm and particularly preferably <0.02 Nm are ideal. The Basic torque of the braking device could also be referred to as the idle torque of the braking device in an unbraked switching state of the braking device.

If the fault protection actuates the braking device in the event of a fault, the braking device preferably brakes the mobility of the steering unit exclusively with the fault braking torque. However, it is also possible that the braking device can apply different braking torques in the event of a fault. For example, the braking torques can be adjusted depending on the incident and/or the steering conditions required for the current driving condition.

Preferably, the mobility of the steering unit can only be braked by means of the braking device in the event of a fault. Preferably, the mobility of the steering unit in normal operation cannot be braked by means of the braking device. This enables a particularly high level of safety and a very robust and at the same time cost-effective implementation of fault prevention. In particular, during normal operation the braking device is at least temporarily and preferably always in an unbraked switching state. In particular, the braking device is in a braked switching state only in the event of a fault. In particular, the braking device is only actuated by the fault protection in the event of a fault.

In an alternative and equally advantageous embodiment, the braking device can also provide a braking torque in normal operation. The braking device is then in a braked switching state at least temporarily in normal operation. It can be provided that the mobility of the steering unit can be braked by means of the braking device in normal operation exclusively with the emergency braking torque. If the braking device is to be actuated in normal operation, the braking device preferably brakes exclusively with the emergency braking torque. The braking device can thus be used, for example, to support the drive device in normal operation. At the same time, this functional extension is particularly safe, since braking can only be carried out in normal operation using the emergency braking torque.

However, it is also possible for the braking device to brake the mobility of the steering unit in normal operation with a defined braking torque, which differs from the emergency braking torque and/or which is (in particular continuously) adjustable. In particular, the adjustable braking torque is not greater than the maximum braking torque.

In particular, the braking device can be switched between a braked and an unbraked switching state. In particular, the braking device can only be switched between a (single) braked and a (single) unbraked switching state. This offers simple and at the same time very robust and reliable emergency protection. In particular, the mobility of the steering unit in the unbraked switching state is not braked by the braking torque of the braking device. In particular, the mobility of the steering unit in the braked switching state is braked with the braking torque of the braking device.

In an advantageous embodiment, the braking device must be actively maintained in the unbraked switching state, in particular with (constant) use of supplied and/or stored energy. In particular, the braking device goes into the braked switching state (independently) without the use of supplied and/or stored energy. This means that the emergency braking torque can also be applied if, for example, there is a power failure.

For example, the braking device brakes due to stored mechanical energy (e.g. spring accumulator) or magnetic energy (e.g. magnetic field of a permanent magnet or magnetizable components of the braking device). Through supplied energy (e.g. electricity for an electrical coil device) or further stored energy (e.g. pressure accumulator), the brake is kept in the unbraked switching state. If the stored or supplied energy is lost, the braking device automatically switches to the braked switching state. In order to return the brake to the unbraked switching state, for example, a pressure accumulator must be charged or a magnetic field must be superimposed by another magnetic field of an electrical coil device.

The energy can, for example, be stored in a permanent magnet and/or a magnetized material of the braking device and/or in a spring accumulator and/or a pressure accumulator or the like. The energy can, for example, be supplied electrically and/or magnetically and/or hydraulically and/or pneumatically or the like.

Preferably, the supply of the braking device with the supplied and/or stored energy can be specifically changed during normal operation. In particular, a braking torque provided in normal operation can be adjusted by means of the changed energy supply. This means that the steering unit can be braked in a targeted manner even in normal operation, without having an adverse effect on the reliability of the fault prevention system. For example, the stored energy can be partially or completely released in order to brake the steering unit during normal operation. It is also possible that during normal operation less energy is specifically supplied in order to generate a specific braking torque. For example, due to the reduced energy supply, a magnetic field of a permanent magnet can be reduced to a lesser extent, so that the braking device slows down the mobility of the steering unit.

In particular, the mobility of the steering unit can be slowed down by stopping the energy supply and/or by discharging the stored energy. In particular, the fault protection is suitable and designed to interrupt the energy supply and/or to discharge the stored energy and thereby the braking device in the event of a fault into the braked switching state.

In an advantageous embodiment, the braking device is in the unbraked switching state without the supply of energy. In particular, the braking device can be switched from the unbraked to the braked switching state (only) with the (continuous) supply of energy. In particular, the braking device must be actively converted to the braked switching state using energy. The energy required for this is particularly preferably stored in the fault protection device. Such a design is particularly safe because the fault protection device does not rely on external energy. In particular, the fault protection device is suitable and designed to use the stored energy to actuate the braking device. In particular, the fault protection device comprises at least one storage means for the energy.

It is possible that the energy supply can be changed in a targeted manner in order to set a braking torque intended in normal operation. In particular, energy is then supplied to the braking device during normal operation, so that it can apply a defined braking torque and preferably the fault braking torque and/or a (infinitely) adjustable braking torque.

In a particularly preferred and advantageous development, the braking device is designed magnetorheologically. In particular, the braking device comprises at least two braking components. In particular, at least one of the braking components can be rotated by the steering unit. In particular, at least one other of the braking components is supported in a rotationally fixed manner (e.g. on the drive device or on the vehicle side). In particular, at least one gap is formed between the braking components. The gap can also be referred to as an effective gap. In particular, the gap is at least partially filled with a magnetorheological medium. In particular, the medium can be influenced in a targeted manner by means of at least one field generating device. The advantages of the present invention can be used particularly well with such a magnetorheological braking device.

In particular, the magnetorheological medium can be specifically influenced by the field generating device in order to be able to adjust the mobility of the brake components relative to one another. In particular, the medium can be influenced by the field generating device in such a way that the mobility of the braking component can be subjected to a specific torque. The torque can also be zero. In particular, by influencing the mobility of the brake components, the mobility of the steering unit is also influenced. In particular, the steering unit is also braked by the braking of the brake components. The steering input device can include at least one transmission means which is suitable and designed to convert the movement of the steering unit into a rotational movement of one of the brake components.

The field generating device is used in particular to generate a magnetic field. In particular, the magnetic field extends at least through the gap and at least in sections through the areas of the brake components surrounding the gap. In particular, the magnetic field corresponds to a magnetic circuit or is part of one. The magnetic circuit is in particular a closed path of a magnetic flux within the braking device. The field generating device comprises in particular at least one electrical coil device and/or at least one permanent magnet device. The permanent magnet device in particular comprises at least one permanent magnet and/or at least one magnetizable material. In particular, a material f of the brake components can be magnetized and provide the permanent magnet device. In particular, the braking device comprises at least one magnetic circuit or can provide one. In particular, the braking device has magnetic saturation, in particular of a magnetic circuit, at least in sections during the provision of the fault braking torque (or in the braked switching state). In particular, a magnetic circuit is a closed path of magnetic flux. If a ferromagnetic body is magnetized, the magnetic forces initially increase in proportion to the strength of the magnetizing field. At some point, however, saturation is reached and the magnetic forces hardly increase, if at all. Saturation magnetization is the maximum possible magnetization of a material. In particular, the magnetic saturation is designed so that the maximum braking torque cannot be exceeded even if the field generating device provides a magnetic field that is stronger than a intended magnetic field due to a disturbance. The braking device can therefore safely and simply not generate a braking torque that is greater than the maximum braking torque.

For example, an electrical coil device could be operated with a higher current or voltage than intended due to a fault. The magnetic saturation in the magnetic circuit or part of the magnetic circuit does not result in a higher braking torque and in such a case the steering unit does not brake excessively. The magnetic saturation can be defined by the targeted choice of material of the magnetic circuit (material type, cross sections, shape) and/or the volume fraction of the magnetorheological medium (e.g. carbonyl iron). In particular, the magnetic saturation is present at least in the sections of the brake components surrounding the gap.

Preferably, the malfunction protection comprises at least one electrical energy storage device for supplying energy to the braking device in the event of a malfunction. In particular, the energy storage provides at least the energy for the field generating device to influence the magnetorheological medium ready. In particular, at least the emergency braking torque can be generated with the energy from the energy storage device. In particular, the energy storage provides the energy for the operation of an electrical coil device (in particular generation of a magnetic flux density). For example, even in the event of a power outage or a power line interruption, the brakes can be reliably braked and the vehicle can be driven safely onto the breakdown lane or to the workshop. The energy storage device can include at least one capacitor device and/or at least one rechargeable battery and/or at least one battery.

In particular, the energy storage is arranged (at least partially) within the braking device. The energy storage is preferably arranged within a housing of the braking device.

In an advantageous further development, the fault protection includes at least one permanent magnet device. In particular, the permanent magnet device provides at least one defined magnetic field. In particular, the mobility of the brake components is influenced by the magnetic field of the permanent magnet device in such a way that the mobility of the steering unit can be braked with the emergency braking torque.

Preferably, the magnetic field of the permanent magnet device can be reduced during normal operation by an electrical coil device. In particular, a defined magnetic field is generated by means of the coil device, which is directed opposite to the magnetic field of the permanent magnet device. In particular, the magnetic field of the permanent magnet device can be reduced in such a way that the braking device is in the unbraked switching state. In particular, the magnetic field can be reduced to such an extent that the mobility of the steering unit is no longer braked. In particular, the braking device only has its basic torque.

If the braking device also applies braking in normal operation is provided, the magnetic field of the permanent magnet device can be reduced with the coil device even in normal operation to such an extent that the desired braking torque is present. In particular, the magnetic field generated by the permanent magnet device in the magnetic circuit is reduced or eliminated by means of the (counter-rotating) magnetic field generated by the electrical coil device.

The permanent magnet device can be provided by a remanence device or at least include one. In particular, the remanence device is suitable and designed to specifically magnetize at least one component of the braking device, so that this component then provides a magnetic field (in the manner of a switchable permanent magnet). In particular, the component can also be demagnetized again (in particular by an electrical coil device).

The steering input device can include at least one control device which is suitable and designed to activate the braking device in normal operation to support the drive device. As a result, the torque acting on the steering unit corresponds in particular to a sum of the torque of the drive device and the braking torque of the braking device. The braking torque of the braking device is in particular the emergency braking torque and/or the maximum braking torque. The torque of the drive device can also be zero. The braking torque used by the braking device can also be adjustable (in particular continuously). The drive device can therefore be made correspondingly smaller and therefore lighter and more compact.

In particular, the control device is suitable and designed to activate the support for generating an end stop and/or for providing an exit aid and/or during deflection of the steering unit from a neutral position and/or during rapid steering (evasive maneuvers). In such situations, support offers many advantages.

In particular, the braking torque used to provide support corresponds to the emergency braking torque and particularly preferably to the fixed emergency braking torque. It is also possible and advantageous for the braking torque used to provide support to be adjustable and preferably continuously adjustable.

The control device can be suitable and designed to control the braking torque provided for support depending on a position of the steering unit and/or a movement parameter of the steering unit and/or an operating state of the vehicle and/or depending on sensor signals and/or

To set information/commands from a control unit and/or forces on the tie rod and/or virtual forces in a virtual vehicle (gaming vehicle/gaming application). In particular, the braking torque can be adjusted so that it complements the current torque of the drive device to form a desired target torque.

In particular, the braking torque used to provide support can be adjusted by supplying the braking device with only a defined portion of the energy that is necessary to change from a braked to an unbraked switching state. For example, this can be done by only reducing the magnetic field of the permanent magnet device in normal operation by the electrical coil device to such an extent that the braking torque required for support remains.

The magnetorheological medium preferably comprises at least one metallic powder. In particular, the metallic powder has a volume fraction of at least 50% and preferably at least 60%. The metallic powder is preferably absorbed in a gaseous carrier medium and, for example, air. The metallic powder can also not be contained in any carrier medium. This is particularly preferred metallic powders equipped with a coating. By using such a medium, a particularly low basic torque can be achieved. At the same time, a particularly high maximum braking torque can be achieved due to the high-volume fraction. In addition, such a medium can be used with consistent properties at the temperatures expected for the steering device. The metallic powder is preferably designed as a carbonyl iron powder (pure iron) or at least includes one. Other magnetorheologically responsive powders are also possible. Alternatively, the carrier medium can be a liquid, e.g. oil, in which the metallic powder is absorbed to form the magnetorheological medium.

In one embodiment, the steering input device can comprise at least two braking devices. In particular, at least a first of the at least two braking devices is provided (exclusively) for fault prevention. In particular, at least a second of the at least two braking devices is provided (exclusively) for braking the mobility of the steering unit in normal operation and/or for supporting the drive device in normal operation. With the second braking device e.g., an increased braking torque for end stops (end stop torque; maximum possible steering angle or maximum steering angle specification) can be generated. This makes it possible to provide a particularly precise and specifically controllable haptic for the steering movements. At the same time, the safety requirements can be implemented particularly easily and economically.

In particular, the second braking device has a maximum braking torque, which is also lower than the maximum torque of the drive device. The second braking device preferably has a braking torque which is less than 6 Nm, preferably less than 4 Nm and in particular a maximum of 3.6 Nm or 3.5 Nm. In particular, the second braking device is in Reference to the braking torque is designed as described for the first braking device. This means that even if the second braking device malfunctions, the steering unit cannot brake excessively or even block.

In a possible embodiment variant, the first brake unit can have a maximum braking torque of less than 2 Nm and the second brake unit can have a maximum braking torque of also less than 2 Nm. This means that the steering unit cannot brake sharply or even lock when both brakes are engaged. However, the user can see a clear difference in the steering feel whether braking is only carried out with one of the first and second braking devices or with both braking devices at the same time. For example, end stops can be clearly displayed haptically.

In particular, the second braking device is in the unbraked switching state in the event of a fault. The second braking device can also be available for fault prevention. In particular, the fault protection is suitable and designed to selectively actuate one of the at least two braking devices in the event of a fault. Such redundancy offers a particularly high level of security.

In particular, the at least two braking devices, preferably the first and the second braking devices, comprise a common gap or effective gap. The at least two braking devices 7 preferably also include two common braking components, which are rotatable relative to one another. In other words, the at least two braking devices share the effective gap and the common braking components. This means that only two brake components and one effective gap do not need to be used for two braking devices.

In particular, the common effective gap is at least partially filled with the magnetorheological medium. In particular, the at least two braking devices each comprise at least one Field generating device for generating a magnetic field. The at least two field generating devices each comprise, in particular, at least one electrical coil device and/or at least one permanent magnet device. The field generating devices are designed in particular as described above. In particular, the first braking device comprises at least one first field generating device. In particular, the second braking device comprises at least one second field generating device. The magnetic fields of the first and second field generating devices preferably act on the common effective gap. It is preferred that the first braking device is equipped with the permanent magnet device and the second braking device is equipped with the coil device.

In particular, the common effective gap is formed circumferentially around one of the brake components. The effective gap can have at least one or at least two or more gap sections. The magnetic fields of the field generating devices can act on the same gap section and/or on a different (adjacent) gap section of the effective gap. In particular, the gap sections are connected to one another and in particular fluidly connected.

In particular, the magnetic fields of the field generating devices run through the (common) brake components and the common effective gap (and in particular through the magnetorheological medium accommodated in the effective gap). Preferably, the magnetic fields of the field generating devices run through a common magnetic circuit. In the event of a fault, this also allows the magnetic field of the first field generating device to be compensated for by the magnetic field of the second field generating device. This is very helpful, for example, in the event of an unwanted maximum current being applied to the coil device. With separate magnetic circuits, this would not be (easily) possible.

It is also possible and preferred that the magnetic fields of the field generating devices run through at least one of their own magnetic circuits and that these magnetic circuits overlap at least in sections. In particular, the common brake components each provide at least one section of the magnetic circuit. In particular, the magnetic circuits overlap at least in one of the common brake components and preferably in both common brake components.

In particular, the field lines within the magnetic circuit run parallel to one another at least in sections. In particular, the magnetic circuit has a homogeneous distribution of field lines (particularly in comparison to the field lines in air). In particular, the magnetic fields flow through a closed magnetic circuit.

The method according to the invention is used to operate a steering input device, as was preferably described previously. In particular, the method is designed so that the steering input device described here can then be operated.

The applicant reserves the right to claim a steering system which includes a steering control device and an actuator device. The actuator device serves in particular to convert a steering movement carried out with the steering unit into a vehicle movement. In particular, the steering unit and the actuator device are only operatively connected according to the steer-by-wire concept.

The steering control device can also be used to control a simulator device or a computer simulation (e.g. in the manner of a computer game or for learning a skill). The applicant reserves the right to claim a steering control device for controlling a simulator device or a computer simulation. The steering input device is designed in particular as before was described for the steering input device according to the invention.

The braking device can be designed as a mechanical, hydraulic, pneumatic, electrical, magnetic and/or electromagnetic brake. The braking device can be designed as a friction brake or at least include one. In particular, the maximum braking torque or the fault braking torque can be set by selecting the friction force.

The braking device can include at least one energy storage device, which provides the energy necessary to apply the emergency braking torque. The braking device can include a mechanical, hydraulic, pneumatic, electrical, magnetic and/or electromagnetic energy storage. For example, a (mechanical) spring, a pressure accumulator, a rechargeable battery, a battery and/or a capacitor or the like can be provided. It is possible that the fault braking torque or the maximum braking torque can be adjusted by selecting the energy storage device.

The drive device in particular comprises at least one drive motor. The drive device is in particular designed to be controllable, so that the torque can be adjusted. A maximum torque of the drive device is understood to mean, in particular, a torque which the drive device can provide at its maximum in normal operation. In particular, the maximum braking torque is smaller than a maximum torque that can be generated jointly by the braking device and the drive device.

In the context of the present invention, a fault in the drive device is understood in particular to mean that the drive device can no longer generate torque. In the event of a malfunction, the drive device in particular fails. For example, an energy supply or a control is the Drive device interrupted or a drive motor is defective or can no longer be activated. In particular, the steering unit would be able to move without resistance in the event of a malfunction if no malfunction protection were provided.

In particular, the braking device does not apply any braking torque during normal operation. In particular, the braking device only applies a basic torque during normal operation. The basic torque of the braking device is preferably less than 0.1 Nm and preferably less than 0.05 Nm and particularly preferably less than 0.02 Nm. The basic moment is due in particular to technical reasons, for example due to frictional forces or inertial forces.

In particular, the basic torque of the braking device is less than 1 Nm and preferably less than 0.5 Nm and particularly preferably close to zero.

A switching time of the braking device is preferably less than 10 ms. A switching time is in particular the time between an inactive state (no braking torque; in particular no magnetic field in the magnetic circuit) and an active state in which at least 90% of the maximum transferable braking torque is available.

In particular, the steering input device comprises at least one control device. The control device is particularly suitable and designed to carry out the (procedural) steps described here using the means described here. In particular, the control device is operatively connected to the components of the steering input device and in particular to the malfunction protection, the drive device, the braking device and/or a sensor device.

Further advantages and features of the present invention result from the exemplary embodiments, which are explained below with reference to the accompanying figures.

### SHOW IN IT

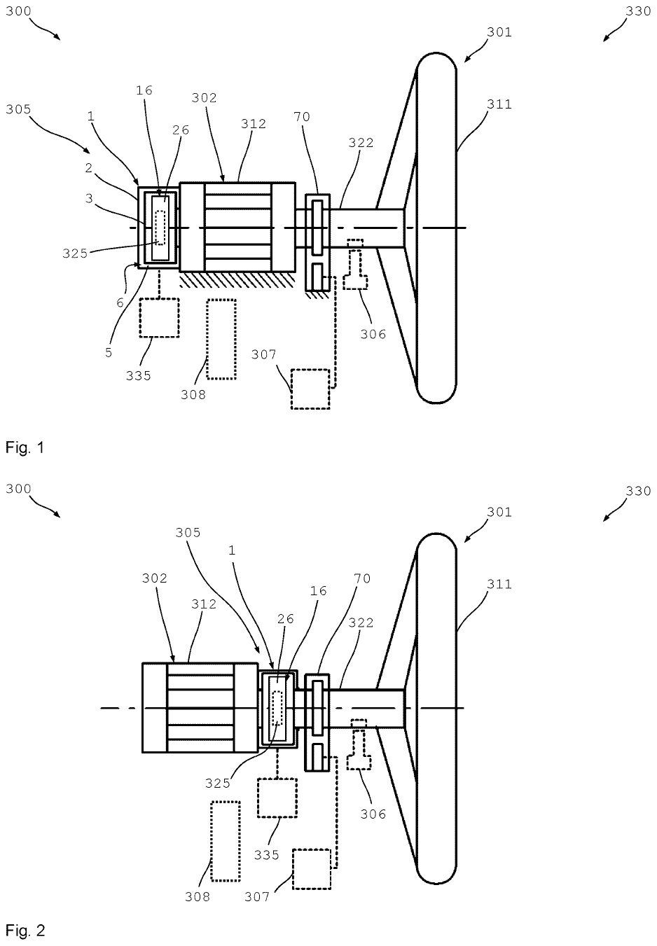

FIG. 1 is a purely schematic representation of a steering control device according to the invention;

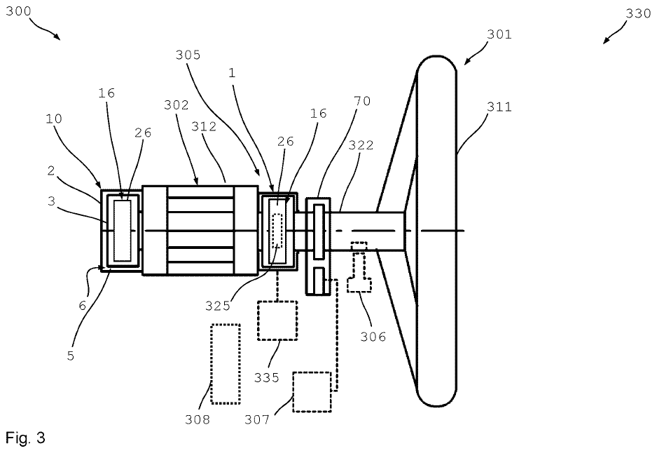

FIG. 2 is a purely schematic representation of another steering input device according to the invention; and

FIG. 3 is a purely schematic representation of a further steering input device according to the invention.

FIG. 1 shows a steering control device 300 according to the invention for controlling a vehicle 330, only partially shown here, according to the steer-by-wire concept. For this purpose, a steering unit 301, designed here as a steering wheel 311, is electrically or electronically connected to an actuator device 307. The actuator device 307 can, for example, adjust one or two or more wheels of the vehicle 330 and thereby convert the steering movement carried out with the steering unit 301 into a vehicle movement. The steering input device 300 is operated here according to the method according to the invention.

The movement or position of the steering unit 301 is detected here with a sensor device 70 and, for example, with a rotation angle sensor. Depending on a sensor signal from the sensor device 70, the steering movement is then implemented accordingly with the actuator device 307.

The steering input device 300 includes a drive device 302 with an electric drive motor 312, which is connected to the steering unit 301 via a steering shaft 322. This generates a torque acting on the steering unit 301, so that the steering unit 301 can be actively rotated to the right or left. With the drive device 302, forces can also be simulated, such as those encountered, for example, would be noticeable on the steering unit 301 with mechanical steering. For this purpose, for example, generates a torque acting on the steering unit 301 (so-called passive torque), which counteracts the manual movement.

The steering input device 300 is equipped with a fault protection system 305 equipped, so that the steering unit 301, for example, cannot be moved without resistance if the drive device 302 fails. For this purpose, the fault protection system 305 has a braking device 1 that is independent of the drive device 302 and can brake the mobility of the steering unit 301 with a targeted braking torque, the so-called fault braking torque. The braking device 1 is flanged here to the drive motor 312 of the drive device 302. The drive motor 312 is attached here to a support structure on the vehicle.

The malfunction protection system 305 shown here can not only prevent the steering unit 301 from being moved without resistance. It can also ensure particularly reliably that the steering unit 301 is not blocked if the drive device 302 fails. For this purpose, the braking device 1 has a maximum braking torque, which is specifically smaller than the maximum torque of the drive device 302.

The maximum braking torque of the braking device 1 is 3.5 Nm or less. The maximum braking torque also corresponds to the emergency braking torque. The emergency braking torque is e.g., fixed and not adjustable or adjustable. In the event of a fault in the drive device 302, the fault protection device 305 actuates the braking device 1 so that it changes from an unbraked to a braked switching state and the steering unit 301 then brakes with the fault braking torque of 3.5 Nm.

With a maximum braking torque of 3.5 Nm or less, the steering unit can be operated manually without any problems. For braking torques above 3.5 Nm, additional technical standards generally have to be met, which in turn place increased demands on the braking device 1 in the event of a fault. This can be prevented with the braking device 1 presented here, whose maximum braking effect is limited to the area mentioned. The braking device 1 shown here can always be safely overturned using normal muscle forces. The braking device 1 is designed here purely as an example as a magnetorheological braking device 1. It comprises two brake components 2, 3 that can be rotated relative to one another, between which a circumferential gap 5 is formed. A magnetorheological medium 6 is arranged in the gap 5. The medium 6 can be influenced in a targeted manner using a field generating device 16. For this purpose, a magnetic field is generated with the field generating device 16, which acts on the medium 6. The medium 6 is influenced by the magnetic field, which in turn influences the mobility of the brake components 2, 3.

For example, the stronger the magnetic field in the gap 6, the more the mobility is slowed down. The relative mobility of the brake components 2, 3 can be braked here so that they can be rotated freely (with the basic torque) or can be braked with the maximum braking torque. This process can be reproduced as often as required, is noiseless and wear-free.

In the embodiment shown here, the fault protection device 305 is equipped with a permanent magnet device 325. This generates a magnetic field in the gap 5, for example with a permanent magnet. This influences the medium 6 in such a way that the mobility of the brake components 2, 3 (and thus also the steering unit 301) is braked with the fault braking torque. As a result, the braking device 1 automatically assumes the braked switching state. For normal operation, the braking device 1 must then be actively held in the unbraked switching state with the supply of energy.

During normal operation, the magnetic field of the permanent magnet device 325 is superimposed and (essentially) eliminated by a corresponding magnetic field. The magnetic field for superposition is generated here by an electrical coil device 26. For the unbraked switching state, the coil device 26 must be supplied with power. If an fault occurs, the coil device 26 is switched off and the steering unit 301 is automatically braked with the fault braking torque. The electrical coil unit including the magnetic circuit and operating principle are optimized and designed for minimal power/energy requirements, so that in the event of a fault, little power is required, preferably less than 10 watts, particularly preferably less than 1 watt.

In addition or as an alternative to a permanent magnet, the permanent magnet device 325 can also be provided by a remanence device. This can magnetize a component of the braking device 1 in such a way that the component provides a magnetic field (e.g. AlNico) even without further power supply. To magnetize the component, e.g. the coil device 26 is used. The magnetic field for superposition in normal operation is also generated here by the coil device 26.

The malfunction protection system 305 shown here can also be designed in such a way that the braking device 1 is in the unbraked switching state when no energy is supplied. For this purpose, no magnetic field is generated during normal operation and the brake components 2, 3 are freely rotatable relative to one another, apart from a basic or idle torque. In the event of a fault, a magnetic field is then generated by means of the coil device 26, so that the steering unit 301 is braked with the fault braking torque.

The energy required for the coil device 26 in the event of a fault is stored here in an electrical energy storage 335 of the fault protection device 305. This can be arranged inside or outside the braking device 1 and includes, for example, a rechargeable battery, capacitor or battery or a combination thereof. The energy storage device 335, which is only shown schematically in the figures for illustrative reasons, is preferably arranged inside, i.e., in the housing of the braking device 1, so that no cables or connections between the energy storage device 335 and the braking device 1 lie outside the housing. This means that the braking torque can be independent of the vehicle's own Main power supply is generated (storage capacity e.g. 20 h).

Preferably, the components of the braking device 1, through which the magnetic field extends during operation (magnetic circuit), are made of a material with a particularly low residual field (near zero) and in particular with no residual field (no residual magnetism-no magnetism remains in the magnetic circuit). For example, silicon steel and/or soft magnetic cobalt-iron alloys (such as Vacoflux, a 17% or 49% cobalt-iron alloy) are used. These materials can be used in solid or solid form or in powder form (e.g. for sintering).

The braking device 1 shown here has the particular advantage that for technical reasons it cannot exceed the emergency braking torque of 3.5 Nm (or its maximum braking torque). Even when energized with a current intensity above the nominal current intensity (in the event of a fault), the braking torque is under no circumstances more than the maximum braking torque. This is because the components that can be magnetized by the coil device 26 are in the state of magnetic saturation when the maximum braking torque is generated. Even in the version with the permanent magnet device 325, the maximum braking torque cannot be exceeded.

In an advantageous embodiment, the braking device 1 can only act with the predefined, in particular constant, emergency braking torque or maximum braking torque in the event of a failure of the drive device 302. The braking device 1 can be switched between the switching states “unbraked” and “braked” (energization of the coil device 26 with a constant current with the corresponding emergency braking torque as a result). During normal operation, the braking device 1 is not activated and therefore, apart from a possible design-related basic friction (=basic torque), does not introduce any braking torque into the steering shaft 322. In the event of a fault, the steering unit 301 can e.g., be applied with a braking torque of the braking device 1 when the steering unit 301 acts from a neutral position (straight ahead) in a direction of rotation towards one of the end stops and is deactivated in the opposite direction until the neutral position is reached. As a result, when the steering unit 301 is deflected from the neutral position, a braking torque, in particular a constant one, can act, while the steering unit 301 moves smoothly when it is steered back into the neutral position. If the neutral position is then left in the opposite direction of rotation, the braking torque is activated. This means that a rudimentary haptic can be provided in the event of a fault.

In one embodiment, the braking device 1 can also be operated in combination with the drive device 302 to influence the torque flow in the steering shaft 322. For example, the end stop and/or the exit aid can be used with the braking device 1 to increase the torque. The drive device 302 can be dimensioned correspondingly smaller.

It is, for example, also possible to use a counter-torque component during the deflection of the steering unit 301 from the neutral position by means of the braking device 1. The drive device 302 can then be dimensioned correspondingly smaller.

Optionally, the braking device 1 can exert a braking torque on the steering unit 301 that is adjustable between the idle torque and the maximum braking torque, in particular continuously (in normal operation, when steering). As a result, the actuation can take place without play or jerks, etc. The drive device 302 can then be dimensioned correspondingly smaller.

The braking device 1 can also share the steering work (force feedback work) with the drive device 302 or a main unit (torque management; shared torque; haptically, safety-related and energetically advantageous division/distribution of the active (e.g. torque of the drive device 302) and passive (braking torque of the braking device 1) torque). The drive device 302 should be designed to be somewhat stronger so that the torque requirements can be met accordingly.

FIG. 2 shows an embodiment of the steering control device 300 with a braking device 1, which is arranged here between the drive motor 312 of the drive device 302 and the steering unit 301.

FIG. 3 shows an embodiment of the steering control device 300 with a first and a second braking device 1, 10. The first braking device 1 serves for the emergency protection system 305 and is designed as previously described. The second braking device 10 serves here to support the drive device 302 in normal operation. The second braking device also has a maximum braking torque of equal to or less than 3.5 Nm.

In the event of a fault, it is provided here that the second braking device 10 is in the unbraked switching state and therefore only has the basic torque. Due to its maximum braking torque, the second braking device 10 can also advantageously serve as a redundant brake in the event of a fault.

The braking devices 1, 10 can e.g., can be connected in series. The braking devices 1, 10 can then apply the maximum passive torque together with the drive device 302 or the main unit in normal operation (torque management). The braking devices 1, 10 preferably make up the majority of it.

The previously described steering control devices 300 can be equipped with a steering lock 306, which mechanically blocks the mobility of the steering unit 301. So can A person can support themselves on the steering unit 301 when getting out or getting in. For example, the steering lock 306 includes a bolt or the like, which is attached to a support structure of the vehicle 330, not shown here, and extends into the steering shaft 322.

As an alternative to the magnetorheological design, the steering input devices 300 described above can also be equipped with a mechanical braking device 1 for fault prevention 305. This can, for example, be a spring-loaded mechanical brake that has a maximum braking torque in the range specified above. For example, a friction brake is provided which is released electromagnetically, hydraulically or pneumatically during normal operation. The braking torque can be adjusted by selecting the springs accordingly.

The invention presented here enables a particularly safe and at the same time robust, space-saving and cost-effective implementation of requirements for steer-by-wire steering systems. The safety regulations (e.g. ADAS; ASIL B to D) are much stricter for force feedback units, which generate torques (active moments) that can no longer be (easily) overcome by muscle power, than for such systems which (only) generate braking torques (passive torques) and/or can be safely overtightened manually.

The driver can easily or safely exceed the maximum braking torque described here. This means that if 3.5 Nm are applied to the steering wheel when the emergency stop 305 is active, the vehicle can still be steered easily and safely. Even in the event of a sudden failure, the driver will not be too frightened (=harmless) if this torque is applied, as this is not far from the torque in normal operation. A sudden drop to the base torque (<1 Nm or <0.1 Nm) would lead to over-steering due to the extreme ease of movement. If the drive device 302 fails, the braking device 1 can intervene, which is designed in such a way that it only delivers 3.5 Nm of braking torque when fully energized. The braking device 1 then goes into magnetic saturation from the magnetic circuit. Thus, even (unforeseen) very high (failsafe) currents in the coil device 26 do not lead to more braking torque.

The chain formation of the (carbonyl iron) particles can be “over-torqued” without any disadvantages. If more than 3.5 Nm of torque is introduced into the steering unit 301, nothing can be damaged. With neither up to 3.5 Nm nor above can blocking or jamming occur, since the completely freely movable carbonyl iron particles are always located between the (solid metallic) brake components 2, 3 rotating relative to one another.

If the magnetic field is then generated by a power storage device (battery/accumulator/capacitor), you get a fallback level that works reliably even if the main power supply fails. The braking device 1 can then either provide a constant current (=constant torque) or a characteristic curve (e.g. lookup table) can be controlled via compact electronics. For this purpose, a sensor or rotary encoder and a torque sensor can even be dispensed with. This results in a very cost-effective and robust fallback level in the event of a failsafe.

This solution can also be combined with the drive device 302 in normal operation, whereby the maximum torque is increased (e.g. 3.5 Nm drive motor plus 3.5 Nm braking device=7 Nm maximum torque). This is sufficient in most cases of normal operation.

In addition, the malfunction protection system 305 can intervene with its braking device 1 if the drive device 302 has a malfunction and would rotate too strongly and/or against the driver's wishes in a (wrong) direction with torque. The Braking device 1 can then brake against it and e.g., prevent the steering unit 301 from being torn out of the driver's hand or the operator's steering request from being adversely distorted.

The steering control devices 300 shown here can also be equipped with a steering unit 301 designed as a handlebar, steering wheel, control stick or the like. The actuator device 307 is designed accordingly for the respective steering unit and is then used, for example, to operate a tail unit of an aircraft or a rudder of a ship. Likewise, the steering input devices 300 shown here can also be designed to control a simulator or a computer simulation. The steering input devices 300 presented here do not necessarily have to be in operative connection with an actuator device 307, which is used to control a real vehicle 330. In a simulator, the actuator device 307 can be accessed, for example, can be dispensed with entirely. Rather, the signals from the steering input device 300 are converted into a simulated or virtual scenario.

The explanations for FIGS. 1 to 3 refer, by way of example, to the application in cars. In other use cases, e.g., when used in trucks or larger vehicles, the emergency braking torque can be designed to be higher, e.g., max. 6 Nm or less. Apart from the optionally higher value of the emergency braking torque for trucks, the explanations for FIGS. 1 to 3 also apply to applications with an emergency braking torque that is more than 3.5 Nm (e.g. 6 Nm or less).

List of reference symbols:

| | |
|---|---|
| 1 | braking device |
| 2, 3 | brake component |
| 5 | gap |
| 6 | medium |
| 10 | braking device |
| 16 | field generating device |
| 26 | coil device |
| 70 | sensor |
| 300 | steering input device |
| 301 | steering unit |
| 302 | drive device |
| 305 | fault protection system |
| 306 | steering lock |
| 307 | actuator device |
| 308 | control device |
| 311 | steering wheel |
| 312 | drive motor |
| 322 | steering shaft |
| 325 | permanent magnet |
| 330 | vehicle |
| 335 | energy storage device |

1.-24. (canceled)

25. A steering input device for controlling a steering movement, the steering input device comprising:
at least one movable steering unit;
at least one drive device for generating a torque to act on the steering unit;
at least one fault protection system having at least one braking device which is independent of the at least one of the drive device, the at least one braking device having a maximum braking torque being smaller than a maximum torque of the drive device;
the at least one fault protection system, in the event of a malfunction of the drive device, being configured to
prevent the steering unit from being blocked or being moved without resistance, and
actuate the braking device to brake the mobility of the steering unit with a targeted emergency braking torque.

26. The steering input device according to claim 25, wherein the maximum braking torque of the braking device is less than 6 Nm.

27. The steering input device according to claim 26, wherein a maximum tangential force on the steering input device caused by the braking device, which counteracts an operating force of a user at a point of application of the steering unit, is less than 30 N.

28. The steering input device according to claim 25, wherein the maximum braking torque of the braking device corresponds to the emergency braking torque, and the mobility of the steering unit is braked by the braking device with the maximum braking torque in the event of a fault in the drive device.

29. The steering input device according to claim 25, wherein a basic torque of the braking device is less than 0.1 Nm.

30. The steering input device according to claim 25, wherein, the braking device cannot apply a braking torque higher than the maximum braking torque, the maximum braking torque corresponds to the emergency braking torque, and the braking device is configured to not exceed the maximum braking torque during a fault.

31. The steering input device according to claim 25, wherein the braking device has a fixed emergency braking torque.

32. The steering input device according to claim 31, wherein the mobility of the steering unit is configured to be braked by the braking device either only with the emergency braking torque or not at all.

33. The steering input device according to claim 25, wherein the mobility of the steering unit is configured to be braked by the braking device only in the event of a fault and the mobility of the steering unit cannot be braked by means of the braking device in a normal operation.

34. The steering input device according to claim 25, wherein the braking device is configured to be switched between a braked and an unbraked switching state, the braking device must be actively held in the unbraked switching state using supplied and/or stored energy, and the braking device changes to the braked switching state without using supplied and/or stored energy.

35. The steering input device according to claim 34, wherein a supply of the braking device with the supplied and/or stored energy is configured to be changed in normal operation and a braking torque provided in normal operation can be adjusted by the changed energy supply.

36. The steering input device according to claim 25, wherein the braking device is configured to be switched between a braked and an unbraked switching state, the braking device is in the unbraked switching state without a supply of energy, and the braking device is configured to be switched from the unbraked to the braked switching state with a supply of energy, the energy being stored in the fault protection system.

37. The steering input device according to claim 25, wherein:
the braking device is a magnetorheological braking device and has at least two braking components;
at least one of the at least two braking components is rotatable by the steering unit, and at least one other of the at least two brake components is supported in a rotationally fixed manner; and
at least one gap, at least partially filled with a magnetorheological medium, is formed between the at least two brake components and the medium is configured to be influenced in a targeted manner by at least one field generating device.

38. The steering input device according to claim 37, wherein the braking device has a magnetic saturation at least in sections when targeted by emergency braking torque, and the magnetic saturation is configured such that the maximum braking torque cannot be exceeded even if the field generating device provides a magnetic field that is stronger than an intended magnetic field due to a disturbance.

39. The steering input device according to claim 38, wherein the fault protection system has at least one electrical energy storage for supplying energy to the braking device in the event of a fault, and the energy storage provides energy for the field generating device to influence the magnetorheological medium configured to generate the emergency braking torque.

40. The steering input device according to claim 39, wherein the energy storage for the braking device lies within a housing of the braking device.

41. The steering input device according to claim 40, wherein the fault protection system has at least one permanent magnet device, a magnetic field of the permanent magnet device is configured to influence the mobility of the brake components and brake the mobility of the steering unit with the emergency braking torque, and the magnetic field of the permanent magnet device is configured to be reduced in normal operation by an electrical coil device so that the braking device is in an unbraked switching state.

42. The steering input device according to claim 25, further comprising at least one control device configured to activate the braking device in normal operation to support the drive device, and wherein a torque acting on the steering unit corresponds to a sum of the torque of the drive device and the braking torque of the braking device.

43. The steering input device according to claim 42, wherein an end stop can be generated as a support to provide an exit aid and/or during a deflection of the steering unit from a neutral position.

44. The steering input device according to claim 43, wherein the braking torque used to provide the support is the fixed emergency braking torque or the braking torque used to provide support is adjustable.

45. The steering input device according to claim 44, wherein the braking torque used to provide the support can be adjusted by supplying the braking device with a predefined energy necessary to change a switching state from a braked to an unbraked switching state.

46. The steering input device according to claim 37, wherein:
the magnetorheological medium has at least one metallic powder; and
the metallic powder has a volume fraction of at least 50% and/or the metallic powder in accommodated in a gaseous or no-carrier medium.

47. The steering input device according to claim 25, wherein the at least one braking device is at least two braking devices, at least a first braking device of the at least two braking devices is provided for the fault protection system, and at least a second braking device of the at least two braking devices is configured to brake the mobility of the steering unit in normal operation.
